(19) United States
(12) Patent Application Publication
(10) Pub. No.: US 2014/0279528 A1
(43) Pub. Date: Sep. 18, 2014

(54) Wearable Authentication Device

(71) Applicant: Motorola Mobility LLC, Libertyville, IL (US)

(72) Inventors: Jiri Slaby, Buffalo Grove, IL (US); Roger W. Ady, Chicago, IL (US)

(73) Assignee: Motorola Mobility LLC, Libertyville, IL (US)

(21) Appl. No.: 14/081,274

(22) Filed: Nov. 15, 2013

Related U.S. Application Data
(60) Provisional application No. 61/787,134, filed on Mar. 15, 2013.

(51) Int. Cl. H04L 29/06; G06Q 20/40; H04W 12/06

(52) U.S. Cl. CPC H04L 63/0853; H04W 12/06; H04L 63/0861; G06Q 20/40145
USPC 705/44; 455/411

(57) ABSTRACT

In embodiments, a wearable authentication device includes a fingerprint sensor to capture a fingerprint image that is used to authenticate a user to an associated device of the wearable authentication device. The wearable authentication device can also include a presence sensor, or a presence sensing mode of the fingerprint sensor, to periodically detect a presence of the user wearing the wearable authentication device, and presence data is communicated to the associated device to maintain operability of the associated device.

### BACKGROUND

An authentication technique utilizes a ring with a unique identifier and near-field communication (NFC) to authenticate use of a device by a user who wears the ring for seamless authentication. For example, a mobile phone or other device of the user can be implemented for NFC communication of the unique identifier from the ring to authenticate the user and initiate operability of the device for use. However, this conventional authentication technique is not specific to a designated user, but rather, only to a person who has the ring. If both the mobile phone and the ring are lost or stolen, any person that has both can be authenticated to the phone, which will then be operable with the potential for misuse as well as the information and data that may be accessed on the device.

### BRIEF DESCRIPTION OF THE DRAWINGS

Embodiments of a wearable authentication device are described with reference to the following Figures. The same numbers may be used throughout to reference like features and components that are shown in the Figures:

FIG. 1 illustrates an example system in which embodiments of a wearable authentication device can be implemented.

FIG. 2 illustrates another example system in which embodiments of a wearable authentication device can be implemented.

FIG. 3 illustrates an example charging device that can be used to charge wearable authentication devices.

FIG. 4 illustrates an example system in which embodiments of a wearable authentication device can be used for a purchase transaction.

FIG. 5 illustrates an example method of a wearable authentication device in accordance with one or more embodiments.

FIG. 6 illustrates another example method of a wearable authentication device in accordance with one or more embodiments.

FIG. 7 illustrates various components of an example electronic device that can implement embodiments of a wearable authentication device.

### DETAILED DESCRIPTION

Embodiments of a wearable authentication device are described, such as a ring that can be worn by a user to authenticate the user to a device that is associated with the ring. In implementations, a ring that a user wears can include a fingerprint sensor to capture a fingerprint image that is used to authenticate the user to an associated device, such as a mobile phone of the user. For example, if a user loses his or her mobile phone and another person finds and turns the phone on, the device will remain inoperable because user authentication cannot be determined without authentication (e.g., a fingerprint image) received from the ring that is worn by the user.

The ring can also include a presence sensor that periodically detects a presence of the user wearing the ring, and presence data is communicated to the associated device to maintain operability of the associated device. If the presence of the user is not detected or maintained, the associated device can be rendered inoperable. For example, if the user loses his or her mobile phone while the device is turned-on or activated, the device will be rendered inoperable because user presence (e.g., contact with the ring) cannot be determined. Similarly, if the user has both the mobile phone and the ring taken, the device will remain inoperable due to a lack of authentication (e.g., the fingerprint image) and/or will be rendered inoperable due to a lack of presence data that indicates continued user contact with the ring. With some fingerprint technologies, such as capacitive, ultrasonic, thermal, pressure, and optical, the fingerprint sensors can also detect user presence rather than implementing a separate presence sensor.

In implementations, a fingerprint sensor may be a fingerprint touch sensor or a fingerprint swipe sensor integrated in a wearable authentication device to capture a fingerprint image. For example, a fingerprint touch sensor can be integrated into the top of a ring, and when the ring is worn on a finger of one hand, the user can touch a finger of the other hand on the fingerprint touch sensor. Alternatively, a fingerprint swipe sensor can be integrated inside a band of a ring to capture the fingerprint image as the ring is placed on a finger of the user. Additionally, the fingerprint swipe sensor can be implemented to capture up to a three-hundred and sixty degree (360°) image (or approximate 360° image) of the finger as the ring is placed on the finger of the user.

In implementations, a presence sensor may be a capacitive sensor that detects user presence based on continued contact with a wearable authentication device, such as contact with a ring from a finger of a user. The fingerprint swipe sensor that is integrated inside a band of a ring may also include presence sensing capability with an integrated presence sensor or mode, such as a capacitive sensor that detects user contact and/or an ultrasonic sensor to detect an ultrasound feedback that confirms user presence. In implementations, a wearable authentication device can also include a data exchange system, such as for near-field communication (NFC) with an NFC chip or with Bluetooth™ low energy (BLTE), to communicate a fingerprint image, an image of a finger, a unique identifier of the wearable authentication device, and/or presence data to the associated device for authentication and to maintain operability of the associated device.

In implementations, the device that is associated with the wearable authentication device is a mobile phone that can be utilized for in-store purchase transactions, and the wearable authentication device validates the user authentication and continued presence to the mobile phone for authorization of an in-store purchase transaction. Alternatively or in addition, the associated device is an in-store transaction device of a merchant system that is implemented for electronic purchase transactions. A user can conduct an electronic purchase transaction with the wearable authentication device (e.g., a ring) that communicates purchase validation data to the in-store transaction device. The merchant system can then authenticate the user based on the purchase validation data to authorize the electronic purchase transaction.

While features and concepts of a wearable authentication device can be implemented in any number of different devices, systems, and/or configurations, embodiments of a wearable authentication device are described in the context of the following example devices, systems, and methods.

FIG. 1 illustrates an example system 100 in which embodiments of a wearable authentication device can be implemented. The example system 100 includes a wearable authentication device 102, such as a ring 104 that a user wears. Other types of wearable authentication devices may include a watch, a wristband, a chain necklace, a belt and buckle, and/or other types of wearable items. The example system also includes an associated device 106, which can be any type of device that is associated with the wearable authentication device 102 and designed for operability based on authentication of a user who wears the wearable authentication device, such as the ring 104. For example, the associated device 106 may be any type of portable electronic device, such as a mobile phone, tablet computer, handheld navigation device, portable gaming device, media playback device, and/or any type of device as further described with reference to the example electronic device shown in FIG. 7.

In implementations, the associated device 106 may be a mobile phone that can be utilized for in-store purchase transactions, and the wearable authentication device 102 provides for user authentication and an indication of continued user presence to the mobile phone for authorization of an in-store purchase transaction. Alternatively, the associated device 106 may be an in-store transaction device of a merchant system that is implemented for electronic purchase transactions. A user can conduct an electronic purchase transaction while wearing the ring 104 that communicates purchase information to the in-store transaction device. The merchant system can then authenticate the user and authorize the electronic purchase transaction.

The associated device 106 may also be any other type of device that is designed for operability based on authentication of a user, such as a door handle that can be opened by a user wearing the ring 104, a vehicle that can be started and driven, or a handgun that can only be fired by a user wearing the ring or other type of wearable authentication device. Although only the one associated device 106 is shown in the example system 100, a wearable authentication device 102 may correspond and be utilized with multiple associated devices. For example, a user may associate the one ring 104 for use with a mobile phone, a tablet or other computer device, access doors for home and work, and with a vehicle of the user.

The wearable authentication device 102 includes a fingerprint sensor 108 to capture a fingerprint image that can be used to authenticate a user to the associated device 106 of the wearable authentication device. For example, the ring 104 includes the fingerprint sensor 108 integrated into the top of the ring as a fingerprint touch sensor, and when the ring is worn on a finger of one hand, the user can touch a finger of the other hand on the fingerprint touch sensor. As used herein, a fingerprint image refers to a digital image and/or any other type of data representing the print pattern features that distinctly identify a user by a fingerprint of his or her finger. The wearable authentication device 102 also includes a presence sensor 110 that periodically detects a presence of the user wearing the wearable authentication device. For example, the ring 104 includes the presence sensor 110 integrated inside the band 112 of the ring as a capacitive sensor that detects user presence based on continued contact with the ring from a finger of a user. In implementations, a fingerprint sensor can also be implemented to detect user presence, rather than implementing a separate presence sensor.

The wearable authentication device 102 can include a power source 114 to power the fingerprint sensor 108. For example, the ring 104 includes the power source 114 and associated circuitry, such as a flexible strip battery, a rechargeable battery, an RF signal received from the associated device 106 and stored for near-field communication (NFC), a charged super-capacitor, and/or any other type of active or passive power source that may be implemented in a wearable authentication device. An example of a charging device that can be used to charge the power source 114 of the wearable authentication device 102 is shown and described with reference to FIG. 3. In implementations, the wearable authentication device may include other components, such as an accelerometer, gyro, infra-red light (IR) light, and/or other components that are utilized for movement detection and intention assessment to anticipate user actions. Generally, these other components assist with power-savings so that the fingerprint sensor, for example, can be maintained in a very low-power state until an indication of use is detected. Alternatively or in addition, the associated device 106 may communicate a wake command or other message to the wearable authentication device to initiate authentication and/or a user presence check.

The wearable authentication device 102 also includes a data exchange system 116, such as for near-field communication (NFC) with an NFC chip or with Bluetooth™ low energy (BLTE), to communicate device data 118 to the associated device 106. The device data may be communicated as an encrypted NFC code and can include a unique device identifier 120 of the wearable authentication device. The device data 118 may also be communicated to the associated device for secure storage via any type of secure wireless or wired data transfer and/or storage methods that utilize encryption and/or secure element. The associated device 106 can receive the device data 118 from the wearable authentication device, such as a secure, theft-proof fingerprint image 122 captured by the fingerprint sensor 108; authentication confirmation if authentication is performed by the wearable authentication device; presence data 124 that indicates user presence (e.g., user contact) with the wearable authentication device; and/or the unique device identifier 120 of the wearable authentication device that is received as a wearable device identifier 126. The device data 118 that corresponds to the wearable authentication device may also include any other type of user and/or device identifying features, information, and data, such as a ring size of the ring 104 that is unique to the user who wears the ring.

Collectively, the device data 118 that the associated device 106 receives from the wearable authentication device 102 is representative of a digital signature 128 of the user who wears the wearable authentication device, such as the ring 104. In implementations, the associated device 106 is designed to receive the fingerprint image 122 and/or the wearable device identifier 126 and authenticate the user who wears the ring, such as by comparing the received device data 118 with the digital signature 128. For example, if a user loses his or her mobile phone and another person finds and turns the phone on, the device will remain inoperable because user authentication cannot be determined without device data 118 communication (e.g., the fingerprint image 122) from the associated wearable authentication device. Alternatively, the wearable authentication device 102 may authenticate the fingerprint image, and then communicate confirmation of the authentication match to the associated device.

The associated device 106 is also designed to periodically receive the presence data 124 and/or the wearable device identifier 126 to verify user presence and maintain the operability of the associated device. If the presence of the user is not detected or maintained, the associated device can be rendered inoperable. For example, if the user loses his or her mobile phone while the device is turned-on or activated, the device will be rendered inoperable because user presence (e.g., contact with the ring 104) cannot be determined without device data 118 communication (e.g., the presence data 124) from the wearable authentication device. Similarly, if the user has both the mobile phone and the wearable authentication device taken, the device will remain inoperable due to a lack of authentication data (e.g., the fingerprint image 122) and/or will be rendered inoperable due to a lack of the presence data 124 that indicates the continued user contact with the wearable authentication device.

FIG. 2 illustrates another example system 200 in which embodiments of a wearable authentication device can be implemented. The example system 200 includes a wearable authentication device 202, such as a ring 204 that a user wears. The example system also includes the associated device 106 (FIG. 1), which can be any type of device that is associated with the wearable authentication device 202 and designed for operability based on authentication of a user who wears the wearable authentication device, such as the ring 204. Other examples and implementations of a wearable authentication device and associated devices are described with reference to FIG. 1.

The wearable authentication device 202 includes a fingerprint sensor 206 to capture a fingerprint image that can be used to authenticate a user to the associated device 106 of the wearable authentication device. For example, the ring 204 includes the fingerprint sensor 206 integrated inside the band 208 of the ring as a fingerprint swipe sensor to capture the fingerprint image as the ring is placed on a finger of the user. In implementations, the fingerprint swipe sensor is flexible and can be formed to encompass the inside of the ring band. In implementations, a fingerprint swipe sensor that is integrated inside the band 208 of the ring 204 can include “wake up” sensing to detect when the ring is being removed, such as by detecting movement of the ring in the direction opposite from the initial authentication swipe when the ring is placed on the finger of a user.

A determination of whether the ring is removed, or being removed, can be based not only on the direction of movement, but also based on the length or distance over which the ring moves, such as at least one inch or other designated measure. Additionally, the detection of the ring removal may initiate a communication from the wearable authentication device to lock one or more of the associated devices, depending on user preferences and/or settings. When an associated device receives an indication that the ring is being removed, the associated device can lock some or all of its functionality for security, or otherwise be rendered inoperable and/or will not re-authenticate. This may be on a device-specific basis, depending on user designations.

Additionally, the fingerprint swipe sensor can be implemented to capture up to a three-hundred and sixty degree (360°) image (or approximate 360° image) of the finger as the ring is placed on the finger of the user. The fingerprint sensors described herein may be implemented as any type of an optical, ultrasonic, thermal, pressure, capacitive, and/or other type of fingerprint sensor that captures images of the print pattern features of fingerprints. Additionally, with some of the fingerprint technologies, such as capacitive, ultrasonic, thermal, pressure, and optical, the fingerprint sensors can also detect user presence rather than implementing a separate presence sensor.

In this example, the fingerprint sensor 206 includes inherent presence sensing capability, such as for user presence detection with an integrated presence sensing mode 210. The fingerprint sensor 206 can include a fingerprint mode to capture the fingerprint image, and include a presence sensor mode to detect user presence. The presence sensing capability can be integrated as a capacitive sensor that detects user contact and/or as an ultrasonic sensor to detect an ultrasound feedback that confirms user presence. An ultrasound feedback can include one or more biometric characteristics of the user that confirm the user presence, and in implementations, the fingerprint sensor 206 is an ultrasonic sensor that periodically detects the one or more biometric characteristics of the user, which indicates user presence.

The biometric characteristics of a user can be detected with penetrating high frequency sound waves from which a visual image of bone and vein structures, as well as blood flow, and heart rate of the user can be detected. For example, the ring 204 includes presence sensing capability with the presence sensing mode 210 that is shown integrated with the fingerprint sensor 206 inside the band 208 of the ring, such as for capacitive sensing and/or ultrasonic sensing that detects and confirms user presence, which may also be based on biometric characteristics of the user. Although described and shown as an integrated sensing capability of the fingerprint sensor 206, the presence sensing may be implemented independent of the fingerprint sensor, such as shown and described with reference to FIG. 1 (e.g., the wearable authentication device 102 includes the separate fingerprint sensor 108 and presence sensor 110).

The wearable authentication device 202 can also include a power source 212 to power the fingerprint sensor 206 and/or the presence sensing mode 210. For example, the ring 204 includes the power source 212 and associated circuitry, such as any type of power source described with reference to FIG. 1. Similarly, the wearable authentication device 202 may include other components, such as an accelerometer, gyro, infra-red light (IR) light, and/or other components that are utilized for movement detection and intention assessment to anticipate user actions and assist with power-savings.

The wearable authentication device 202 also includes a data exchange system 214, such as for near-field communication (NFC) with an NFC chip or with Bluetooth™ low energy (BLTE), to communicate device data 216 to the associated device 106. The device data may be communicated as an encrypted NFC code and can include a unique device identifier 218 of the wearable authentication device. The device data 216 may also be communicated to the associated device for secure storage via any type of secure wireless or wired data transfer and/or storage methods that utilize encryption and/or secure element. The associated device 106 can receive the device data 216 from the wearable authentication device, such as the fingerprint image 122 captured by the fingerprint sensor 206; the presence data 124 that indicates user presence based on biometrics of the user; an image 220 of the finger as captured by the ultrasonic fingerprint swipe sensor; and/or the unique device identifier 218 of the wearable authentication device that is received as a wearable device identifier 222. The device data 216 that corresponds to the wearable authentication device may also include any other type of user and/or device identifying features, information, and data, such as a ring size of the ring 204 that is unique to the user who wears the ring.

Collectively, the device data 216 that the associated device 106 receives from the wearable authentication device 202 is representative of the digital signature 128 of the user who wears the wearable authentication device, such as the ring 204. In this example, the digital signature 128 also includes the image 220 of the finger on which the user wears the ring 204, in addition to the fingerprint image 122, the presence data 124, and/or the wearable device identifier 222. In implementations, the associated device 106 is designed to receive the fingerprint image 122, the image 220 of the finger, and/or the wearable device identifier 222 and authenticate the user who wears the ring, such as by comparing the received device data 216 with the digital signature 128. Alternatively, the wearable authentication device 202 may authenticate the fingerprint image, and then communicate confirmation of the authentication match to the associated device. The associated device 106 is also designed to periodically receive the presence data 124 and/or the wearable device identifier 222 to verify user presence and maintain the operability of the associated device. If the presence of the user is not detected or maintained, the associated device can be rendered inoperable.

In other implementations of a wearable display device, such as a ring that a user wears, the ring may include features and/or components of both the ring 104 described with reference to FIG. 1 and the ring 204 described with reference to FIG. 2. For example, a ring may be implemented with a capacitive presence sensor for immediate detection of user presence, a fingerprint swipe sensor to initially capture a fingerprint image as the ring is placed on a finger of the user and then capture a complete image of the finger, and then transition to ultrasonic biometric presence checks to detect continued user presence of the user wearing the ring.

FIG. 3 illustrates an example charging device 300 that can be used to charge the power source of a wearable authentication device, such as the power source 114 of ring 104 described with reference to FIG. 1 and/or the power source 212 of ring 204 described with reference to FIG. 2. The charging device 300 includes a base 302 that supports a tapered ring charging column 304 with charging elements 306 that charge the power source of one or more rings placed on the tapered ring charging column. The power source of a ring may be charged inductively or by other wireless charging techniques with the charging device 300. For example, the power source of a ring may be charged with a contact charging system (not shown) that is implemented as part of the tapered ring charging column 304. Alternatively, the power source of a ring may be charged with a charging pad, or with a wired connection to a small receptacle integrated in the ring itself to plug-in and charge the power source of the ring. As shown at 308, the tapered ring charging column 304 of the charging device 300 is designed to accommodate multiple rings 104, 204 of varying sizes.

FIG. 4 illustrates an example system 400 in which embodiments of a wearable authentication device can be used for a purchase transaction. The example system 400 includes a wearable authentication device 402 worn by a user, such as the ring 104 described with reference to FIG. 1 or the ring 204 described with reference to FIG. 2. Also shown is the associated device 106 (e.g., a mobile phone) that is associated with the wearable authentication device as described with reference to FIGS. 1 and 2. In this example, a merchant system 404 includes an in-store transaction device 406 in communication with a merchant server 408 via a network 410. In implementations, the merchant server 408 may be implemented as an independent device or service (e.g., as shown), or may be implemented as an integrated component or service of the in-store transaction device 406. Alternatively or in addition, the merchant server 408 can be implemented as a network-based service (e.g., in the cloud) as a network of one or more server devices to facilitate theft-proof purchase transactions that are initiated with a wearable authentication device.

Any of the devices and servers described herein can communicate via the network 410, which can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, cell-phone provider, and/or Internet service provider.

In addition to the associated device 106, the in-store transaction device 406 is also an associated device of the wearable authentication device 402, and a user can conduct an electronic purchase transaction with the wearable authentication device (e.g., the ring) that communicates purchase validation data 412 to the in-store transaction device. Depending on the wireless communication range of the ring, the user may complete the purchase transaction without the user approaching the in-store transaction device 406 with the hand that the user wears the ring. If the wireless communication range of the ring is not sufficient (such as for NFC), the user can approach the in-store transaction device 406 with the hand that includes the ring. Alternatively, the purchase transaction may be completed utilizing the associated device 106 in the same manner. Similar to the digital signature 128 that corresponds to a user and/or a wearable authentication device, as described with reference to FIGS. 1 and 2, the purchase validation data 412 can include a fingerprint image from a finger of the user, an image of the finger, presence data that indicates continued user presence (e.g., the user is wearing the ring), a unique device identifier of the wearable authentication device, and/or any other type of identifying information and data that may be included to enable an electronic purchase transaction.

In an implementation, the in-store transaction device 406 can communicate the purchase validation data 412 to the merchant server 408 that authenticates the user and corresponding wearable authentication device, such as by comparison of the purchase validation data 412 to a stored digital signature 414 that corresponds to the user. The merchant server 408 can then initiate a transaction authorization 416 that is communicated back to the in-store transaction device 406 to authorize the electronic purchase transaction. Additionally, the merchant server can then communicate purchase data 418 of the transaction for display at the associated device 106, such as the mobile phone of the user who can then see the details of the purchase transaction. In an alternate implementation, the in-store transaction device 406 receives the purchase validation data 412 for comparison with a stored digital signature, authorizes the purchase transaction, and communicates the purchase data to the associated device 106 for a theft-proof transaction.

Example methods 500 and 600 are described with reference to FIGS. 5 and 6 in accordance with implementations of a wearable authentication device. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 5 illustrates example method(s) 500 of a wearable authentication device. The order in which the method is described is not intended to be construed as a limitation, and any number or combination of the described method operations can be performed in any order to perform a method, or an alternate method.

At 502, a fingerprint image is captured with a fingerprint sensor that is integrated in a wearable authentication device. For example, the fingerprint sensor 108 of the wearable authentication device 102 (FIG. 1) is integrated into the top of the ring 104 as the fingerprint touch sensor that captures a fingerprint image, such as when the ring is worn on a finger of one hand and the user touches a finger of the other hand on the fingerprint touch sensor. Alternatively, the fingerprint sensor 206 of the wearable authentication device 202 (FIG. 2) is integrated inside the band 208 of the ring 204 as the fingerprint swipe sensor that captures the fingerprint image as the ring is placed on a finger of the user. The fingerprint images that are captured by the fingerprint sensors can be communicated to the associated device 106 and used to authenticate the user to the associated device.

At 504, an image of the finger is captured up to a three-hundred and sixty degree (360°) image when the ring is placed on a finger of the user. For example, the fingerprint sensor 206 that is integrated inside the band 208 of the ring 204 as the fingerprint swipe sensor captures up to the three-hundred and sixty degree (360°) image (or approximate 360° image) of the finger as the ring is placed on the finger of the user.

At 506, the fingerprint image and/or the image of the finger is communicated to an associated device that authenticates the user. For example, the wearable authentication device 102 communicates the fingerprint image 122 (e.g., may be encrypted or not encrypted) to the associated device 106, and the wearable authentication device 202 communicates the fingerprint image 122 and/or the image 220 of the finger to the associated device. The associated device 106 maintains the digital signature 128 that corresponds to the user and authenticates the user by comparison of the digital signature to the device data that is received from the wearable authentication device, such as the fingerprint image, the image of the finger, the presence data, and/or the unique identifier of the wearable authentication device. Alternatively, the wearable authentication device 102 may authenticate the fingerprint image and/or the image of the finger, and then communicate an identifier and/or confirmation of the authentication match to the associated device.

At 508, a presence of the user wearing the wearable authentication device is detected. For example, the presence sensor 110 of the wearable authentication device 102 that is implemented inside the band 112 of the ring 104 is a capacitive sensor that detects the presence of the user who is wearing the ring based on user contact with the ring, such as the continued contact of a finger on the inside of the band of the ring. Alternatively, the presence sensing mode 210 of the wearable authentication device 202 is implemented for capacitive sensing, ultrasonic sensing to detect ultrasound feedback that confirms user presence, and/or any other type of sensing user presence that may be utilized, such as with optical, thermal, and pressure sensing techniques. The ultrasonic sensing can also detect body and/or biometric characteristics of the user that confirm user presence. As described above, the sensing capabilities of the presence sensing mode 210 may be integrated with the fingerprint sensor 206, or presence sensors can be implemented independent of the fingerprint sensor.

At 510, presence data is communicated to the associated device to maintain operability of the associated device if the user is in proximity to the associated device. For example, the wearable authentication device 102 communicates the presence data 124 to maintain operability of the associated device 106 if the user is in proximity to the associated device, which may be determined via wireless connection (e.g., BTLE). Similarly, the wearable authentication device 202 communicates the presence data 124 to the associated device 106 to maintain operability of the associated device. The method continues at 508 to periodically detect the presence of the user wearing the wearable authentication device.

If the presence data periodically indicates continued user presence to the associated device, then operability of the associated device is maintained to allow continuous use of the associated device and/or services as an authenticated user. Alternatively, if the presence data does not indicate user presence, such as if a wearable authentication device has been removed from the user and the presence sensor no longer senses user contact, then the user loses his or her authentication status and the associated device can be rendered inoperable. If the user loses his or her authentication status and the associated device is rendered inoperable, the method can continue at 502 to recapture the fingerprint image of a finger of the user to re-authenticate the user to the associated device.

FIG. 6 illustrates other example method(s) 600 of a wearable authentication device, and is generally described with reference to a ring that a user wears. The order in which the method is described is not intended to be construed as a limitation, and any number or combination of the described method operations can be performed in any order to perform a method, or an alternate method.

At 602, a fingerprint image of a user who puts a ring on a finger is captured. For example, the fingerprint sensor 108 (FIG. 1) that is integrated into the top of the ring 104 as the fingerprint touch sensor captures a fingerprint image, such as when the ring is worn on a finger of one hand and the user touches a finger of the other hand on the fingerprint touch sensor. Alternatively, the fingerprint sensor 206 (FIG. 2) that is integrated inside the band 208 of the ring 204 as the fingerprint swipe sensor captures the fingerprint image as the ring is placed on a finger of the user.

At 604, an image of the finger is captured as the ring is placed on the finger of the user. For example, the fingerprint sensor 206 that is integrated inside the band 208 of the ring 204 as the fingerprint swipe sensor captures the image of the finger as the ring is placed on the finger of the user. At 606, the fingerprint image and/or the image of the finger is communicated to an associated device that authenticates the user. For example, the ring 104 communicates the fingerprint image 122 to the associated device 106, and the ring 204 communicates the fingerprint image 122 and/or the image 220 of the finger to the associated device. Alternatively, a ring may authenticate the fingerprint image and/or the image of the finger, and then communicate an identifier and/or confirmation of the authentication match to the associated device.

At 608, a determination is made as to whether the user is authenticated based on at least the fingerprint image and/or based on the finger image. For example, the associated device 106 maintains the digital signature 128 that corresponds to the user and authenticates the user by comparison of the digital signature to the device data that is received from a ring, such as the fingerprint image, the image of the finger, the presence data, and/or the unique identifier of the ring. If the user is not authenticated (i.e., “no” from 608), then the associated device remains or is rendered inoperable at 610, and the method continues at 602 to capture a fingerprint image of a user who puts on the ring. Alternatively, if the user is authenticated (i.e., “yes” from 608), then the associated device is operable for use by the user.

At 612, a presence of the user wearing the ring is periodically detected. For example, the presence sensor 110 of the wearable authentication device 102 that is implemented inside the band 112 of the ring 104 is a capacitive sensor that detects the presence of the user who is wearing the ring based on user contact with the ring, such as the continued contact of a finger on the inside of the ring band. Alternatively, the presence sensing mode 210 of the fingerprint sensor 206 of the wearable authentication device 202 is implemented for capacitive sensing that detects user presence, ultrasonic sensing to detect ultrasound feedback that confirms user presence, and/or any other type of sensing user presence that may be utilized, such as with optical, thermal, and pressure sensing techniques. As described above, ultrasonic sensing can detect body and/or biometric characteristics of the user that confirm user presence.

At 614, presence data is communicated to the associated device to maintain the operability of the associated device if the user is in proximity to the associated device. For example, the data exchange system 116 of the ring 104 communicates the presence data 124 to maintain operability of the associated device 106 if the user is in proximity to the associated device, which may be determined via wireless connection (e.g., BTLE). Similarly, the data exchange system 214 of the ring 204 communicates the presence data 124 to the associated device 106. If the presence data periodically indicates continued user presence to the associated device, then operability of the associated device can be maintained to allow continuous use of the associated device and/or services by an authenticated user. Alternatively, if the presence data does not indicate user presence, such as if a ring has been removed from the user and the presence sensor no longer senses user contact, then the user loses his or her authentication status and the associated device can be rendered inoperable.

At 616, a determination is made as to whether the presence of the user is confirmed. For example, the associated device 106 receives the presence data 124 from a wearable authentication device (e.g., the ring 104 or the ring 204) and confirms whether the presence data indicates the user is wearing the ring. If the presence of the user is confirmed (i.e., “yes” from 616), then the method continues at 612 to detect the presence of the user wearing the ring and, at 614, to communicate the presence data to the associated device to maintain operability of the device. If the presence of the user is not confirmed (i.e., “no” from 616), then the associated device is rendered inoperable at 610, and the method continues at 602 to capture (or recapture) a fingerprint image of a user who puts on the ring.

FIG. 7 illustrates various components of an example device 700 that can be implemented as any wearable authentication device, server, or associated device described with reference to any of the previous FIGS. 1-6. In embodiments, the example device may be implemented in any form of a device that is associated with a wearable authentication device, and as a device that receives device data from the wearable authentication device to authenticate a user of the device. For example, an associated device may be any one or combination of a communication, computer, playback, gaming, entertainment, mobile phone, and/or tablet computing device, as well as an in-store transaction device that facilitates an electronic purchase transaction with a wearable authentication device. An associated device may also be any other type of device that is designed for operability based on authentication of a user, such as a door handle that can be opened by a user wearing a ring, a vehicle that can be started and driven, or a handgun that can only be fired by a user wearing the ring or other type of wearable authentication device.

The device 700 includes communication transceivers 702 that enable wired and/or wireless communication of device data 704, such as the wearable authentication device data, the digital signature data, and/or the purchase validation data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The device 700 may also include one or more data input ports 706 via which any type of data, media content, and/or inputs can be received, such as user-selectable inputs, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to components, peripherals, or accessories such as microphones and/or cameras.

The device 700 includes a processor system 708 of one or more processors (e.g., any of microprocessors, controllers, and the like) and/or a processor and memory system (e.g., implemented in an SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 700 also includes one or more memory devices 712 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The device 700 may also include a mass storage media device.

A memory device 712 provides data storage mechanisms to store the device data 704, other types of information and/or data, and various device applications 714 (e.g., software applications). For example, an operating system 716 can be maintained as software instructions with a memory device and executed by the processor system 708. The device applications may also include a device manager, such as any form of a control application, software application, signal-processing and control module, code that is native to a particular device, a hardware abstraction layer for a particular device, and so on. The device may also include an authentication manager 718 that authenticates a user who wears a wearable authentication device, such as when the device 700 is implemented as an associated device of a wearable authentication device as described with reference to FIGS. 1-6.

The device 700 also includes an audio and/or video processing system 720 that generates audio data for an audio system 722 and/or generates display data for a display system 724. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 726. In implementations, the audio system and/or the display system are integrated components of the example device.

The device 700 can also include a power source 728, such as when the device is implemented as a wearable authentication device. The power source may include a charging and/or power system, and can be implemented as a flexible strip battery, a rechargeable battery, an RF signal received from an associated device and stored for near-field communication (NFC), a charged super-capacitor, and/or any other type of active or passive power source.

Although embodiments of a wearable authentication device have been described in language specific to features and/or methods, the subject of the appended claims is not necessarily limited to the specific features or methods described. Rather, the specific features and methods are disclosed as example implementations of a wearable authentication device.

1. A wearable authentication device, comprising:
at least one sensor configured to capture a fingerprint image that is used to authenticate a user to an associated device of the wearable authentication device and at least periodically detect a presence of the user wearing the wearable authentication device; and
a data exchange system configured to communicate presence data to maintain operability of the associated device.

2. The wearable authentication device as recited in claim 1, further comprising a processor coupled to the said at least one sensor by a circuit, the processor configured to process the fingerprint image and determine the presence of the user.

3. The wearable authentication device as recited in claim 2, wherein the processor is configured to authenticate a fingerprint of the user based on the fingerprint image.

4. The wearable authentication device as recited in claim 2, wherein the processor is configured to detect a break in contact between the user and the wearable authentication device.

5. The wearable authentication device as recited in claim 1, wherein the data exchange system is configured to communicate the fingerprint image and the presence data to the associated device for the associated device to authenticate the user and maintain full operability of the associated device.

6. The wearable authentication device as recited in claim 1, wherein the data exchange system is configured to:
communicate the fingerprint image to the associated device that authenticates the user; and
communicate the presence data to the associated device to maintain the operability of the associated device.

7. The wearable authentication device as recited in claim 1, wherein said at least one sensor includes a presence sensor.

8. The wearable authentication device as recited in claim 7, wherein said at least one sensor further includes a fingerprint sensor.

9. The wearable authentication device as recited in claim 8, wherein the fingerprint sensor is one of:
a fingerprint touch sensor configured to capture the fingerprint image; or
a fingerprint swipe sensor configured to capture the fingerprint image as the wearable authentication device is placed on a finger of the user.

10. The wearable authentication device as recited in claim 8, wherein the presence sensor is one of:
a capacitive sensor configured to detect user presence based on continued contact with the wearable authentication device; or
an ultrasonic sensor configured to detect an ultrasound feedback that confirms user presence.

11. The wearable authentication device as recited in claim 10, wherein the ultrasound feedback includes a biometric and wellness characteristic of the user that confirms the user presence.

12. The wearable authentication device as recited in claim 1, wherein said at least one sensor includes a fingerprint swipe sensor that is configured to capture an image of the finger as the wearable authentication device is placed on the finger of the user.

13. The wearable authentication device as recited in claim 12, wherein the wearable authentication device is a ring and the fingerprint swipe sensor is configured inside a band of the ring to capture the image of the finger up to a three-hundred and sixty degree (360°) image.

14. The wearable authentication device as recited in claim 1, wherein said at least one sensor includes a fingerprint swipe sensor that is configured to detect when the wearable authentication device is being removed from the finger of the user.

15. The wearable authentication device as recited in claim 1, wherein the associated device is a mobile phone implemented for an in-store purchase transaction, and the wearable authentication device is configured to validate user authentication and continued presence to the mobile phone for authorization of the in-store purchase transaction.

16. A method, comprising:
capturing a fingerprint image with a fingerprint sensor that is integrated in a wearable authentication device, the fingerprint image used to authenticate a user to an associated device of the wearable authentication device;
detecting a presence of the user wearing the wearable authentication device; and
communicating presence data to the associated device to maintain operability of the associated device.

17. The method as recited in claim 16, further comprising:
communicating the fingerprint image to the associated device that authenticates the user.

18. The method as recited in claim 16, wherein:
the fingerprint sensor is integrated in a ring as a fingerprint touch sensor said capturing the fingerprint image; and
detecting the presence of the user includes detecting the presence of the user wearing the ring with a capacitive sensor that detects user presence based on continued contact with the ring.

19. The method as recited in claim 16, wherein:
the fingerprint sensor is integrated inside a band of a ring as a fingerprint swipe sensor said capturing the fingerprint image as the ring is placed on a finger of the user; and
the fingerprint swipe sensor said detecting the presence of the user wearing the ring.

20. The method as recited in claim 19, wherein said detecting the presence of the user wearing the ring by at least one of capacitive sensing that detects the presence of the user, or ultrasonic sensing that detects an ultrasound feedback that confirms user presence.

21. The method as recited in claim 19, further comprising capturing an image of the finger up to a three-hundred and sixty degree (360°) image when the ring is placed on the finger of the user.

22. The method as recited in claim 19, further comprising detecting when the ring is being removed from the finger of the user.

23. The method as recited in claim 22, further comprising locking the associated device when said detecting the ring being removed from the finger of the user.

24. A system, comprising:
a wearable authentication device configured to capture a fingerprint image of a user and periodically detect a presence of the user wearing the wearable authentication device; and
an associated device of the wearable authentication device, the associated device configured for operability based on the fingerprint image used to authenticate the user to the associated device, and based on presence data that indicates the user maintains contact with the wearable authentication device.

25. The system as recited in claim 24, wherein the wearable authentication device is configured to:
communicate the fingerprint image to the associated device that is configured to authenticate the user; and
communicate the presence data to the associated device to maintain the operability of the associated device.

26. The system as recited in claim 24, wherein the wearable authentication device includes:
a fingerprint touch sensor configured to capture the fingerprint image; and
a capacitive sensor configured to detect user presence based on the user maintaining contact with the wearable authentication device.

27. The system as recited in claim 24, wherein the wearable authentication device includes a fingerprint swipe sensor configured to:
capture the fingerprint image as the wearable authentication device is placed on a finger of the user; and
detect an ultrasound feedback that confirms user presence.

28. The system as recited in claim 27, wherein:
the fingerprint swipe sensor is an ultrasonic sensor;
the ultrasound feedback includes a biometric characteristic of the user that confirms the user presence; and
the ultrasonic sensor is configured to periodically detect the biometric characteristic of the user.

29. The system as recited in claim 27, wherein the wearable authentication device is a ring and the fingerprint swipe sensor is configured inside a band of the ring to capture an image of the finger up to a three-hundred and sixty degree (360°) image.

30. The system as recited in claim 24, wherein the associated device is configured to:
maintain a digital signature that corresponds to the user based on at least one of the fingerprint image, the presence data, and a unique identifier of the wearable authentication device; and
authenticate the user based on the digital signature.

31. The system as recited in claim 24, wherein the associated device is a mobile phone implemented for an in-store purchase transaction, and the mobile phone is configured to authenticate the user and validate continued presence of the user to authorize the in-store purchase transaction.

32. The system as recited in claim 24, wherein:
the associated device is an in-store transaction device of a merchant system implemented for an electronic purchase transaction;
the wearable authentication device is configured to communicate purchase validation data to the associated device to conduct the electronic purchase transaction; and
the merchant system is configured to authenticate the user based on the purchase validation data to authorize the electronic purchase transaction.

33. A wearable authentication device, comprising:
at least one sensor configured to capture a fingerprint image that is used to authenticate a user to an associated device of the wearable authentication device and at least periodically detect a presence of the user wearing the wearable authentication device;
a circuit coupled to said at least one sensor, the circuit including a processor configured to process the fingerprint image and determine the presence of the user; and
a data exchange system configured to communicate presence data to maintain operability of the associated device.

34. The wearable authentication device according to claim 33, wherein the processor is configured to authenticate a fingerprint of the user based on the fingerprint image.

35. The wearable authentication device according to claim 33, wherein the processor is configured to detect a break in contact between the user and the wearable authentication device.

36. The wearable authentication device according to claim 33, wherein the data exchange system is configured to communicate the fingerprint image and the presence data to the associated device for the associated device to authenticate the user and maintain full operability of the associated device.
